(19) United States
(12) Patent Application Publication
(10) Pub. No.: US 2006/0048890 A1
(43) Pub. Date: Mar. 9, 2006

(54) Production method of annular, fiber-reinforced composite structure, and annular frame constituted by such structure for aircraft fuselages

(75) Inventors: Keiichi Sato, Saitama-ken (JP); Hiroki Takashima, Kyoto (JP)

Correspondence Address: SUGHRUE MION, PLLC, 2100 PENNSYLVANIA AVENUE, N.W., SUITE 800, WASHINGTON, DC, 20037, US

(73) Assignees: Honda Motor Co., Ltd.; Murata Machinery, Ltd.

(21) Appl. No.: 11/211,596

(22) Filed: Aug. 26, 2005

(30) Foreign Application Priority Data
Sep. 6, 2004 (JP) 2004-258671

(51) Int. Cl. B29C 65/00

(52) U.S. Cl. 156/285; 156/196; 156/227

(57) ABSTRACT

A method for producing an annular, fiber-reinforced composite structure comprising (a) forming reinforcing fibers into an annular base preform having an annular flat-plate web and a flange substantially perpendicular to the web, (b) bonding an annular, reinforcing, flat-plate fiber preform to the web of the annular base preform, (c) bonding a cylindrical, reinforcing fiber preform to the flange of the annular base preform to form an integral, annular fiber preform, (d) impregnating the resultant annular fiber preform with a matrix resin, and (e) curing the matrix resin.

### FIELD OF THE INVENTION

The present invention relates to a method for producing an annular structure of a fiber-reinforced composite, and an annular frame comprising such structure for aircraft fuselages.

### BACKGROUND OF THE INVENTION

As structure members for aircrafts, etc., annular structures composed of light-weight, high-strength, fiber-reinforced composites are widely used. The annular, fiber-reinforced composite structures, which generally have flanges, etc. to be bonded to other members, have conventionally been produced by combining pluralities of planar prepregs by stitching, and integrally curing them. For instance, JP 2001-310798 A discloses a method for producing an inner frame member having a complicated cross section such as an L-shaped cross section, etc. for fuselage structures, by heat-compressing pluralities of planar prepregs placed on a molding die in an autoclave. However, because the production method using pluralities of planar prepregs have many steps, it is disadvantageous in high production cost.

Proposed to reduce the production cost is a method for producing an annular, fiber-reinforced composite structure by forming reinforcing fibers into an annular preform having a desired shape, and integrally impregnating the annular preform with a matrix resin. From the aspect of the degree of freedom of fiber orientation, an annular preform substrate is preferably a braid. When a braid is used, as shown in FIG. 23, for instance, a flat-plate braid 50 formed cylindrically is partially and radially deformed in the entire circumference thereof to form an annular preform 10 having an annular flat-plate web 121 and a radial flange 122 substantially vertical to the web 121.

However, the braid is generally a cylindrical body composed of center fibers oriented along a longitudinal direction of a mandrel, and slanting fibers spirally oriented relative to the longitudinal direction of the mandrel at a predetermined braiding angle, which has a uniform basis weight in its entirety. Accordingly, the braid 50 having enough basis weight to meet the rigidity requirement of the flange 122 is too rigid for the web 121. In addition, it suffers from unnecessary increase in weight and a material cost.

Because the braid is formed by cylindrically weaving center fibers with slanting fibers as described above, it is not easy to partially control the basis weight of the braid 50, such that each of the web 121 and the flange 122 has a basis weight in a desired range. JP 2001-30361 A discloses a method for forming a cylindrical multi-layer preform on a mandrel in a braider. This method, however, fails to partially control the basis weight of the braid.

### OBJECT OF THE INVENTION

Accordingly, an object of the present invention is to provide an annular, fiber-reinforced composite structure having a web and a flange each having optimum rigidity by a relatively small number of steps at a low cost, and an annular frame constituted by such structure for aircraft fuselages.

### DISCLOSURE OF THE INVENTION

As a result of intense research in view of the above object, the inventors have found that an annular, fiber-reinforced composite structure having a web and a flange with optimum rigidity can be produced with a reduced number of steps and a low cost, by forming as an annular preform of reinforcing fibers having a web and a flange, an integral structure comprising (a) an annular base preform comprising an annular flat-plate web and a flange substantially perpendicular to the web, (b) an annular, reinforcing flat-plate preform bonded to the web of the annular base preform, and (c) a cylindrical, reinforcing preform bonded to the flange of the annular base preform, and impregnating the integral structure with a matrix resin. The present invention has been completed based on this finding.

The method for producing an annular, fiber-reinforced composite structure according to the present invention comprises the steps of (a) forming reinforcing fibers into an annular base preform having an annular flat-plate web and a flange substantially perpendicular to the web, (b) bonding an annular, reinforcing, flat-plate fiber preform to the web of the annular base preform, (c) bonding a cylindrical, reinforcing fiber preform to the flange of the annular base preform to form an integral, annular fiber preform, (d) impregnating the resultant annular fiber preform with a matrix resin, and (e) curing the matrix resin.

The annular base preform is preferably formed by overlap-bonding end portions of at least one circular strip obtained by deforming an elongated planar strip composed of reinforcing fibers to a shape having a circular flat portion and a portion substantially perpendicular to the flat portion. The annular, reinforcing flat-plate preform is preferably formed by overlap-bonding end portions of at least one circular, planar strip obtained by deforming an elongated planar strip composed of reinforcing fibers to a circular shape. The cylindrical, reinforcing preform is preferably formed by overlap-bonding both end portions of at least one annular strip obtained by annularly deforming an elongated planar strip composed of reinforcing fibers.

When the annular, reinforcing flat-plate preform and the cylindrical, reinforcing preform are bonded to the annular base preform to form the annular fiber preform, they are preferably positioned such that their overlapped portions deviate from each other in a circumferential direction of the annular fiber preform. With the circumferential deviation of the overlapped portions, the annular fiber preform has high rigidity.

The annular base preform preferably has an L-, U- or H-shaped cross section. The annular, reinforcing flat-plate preform and the cylindrical, reinforcing preform are bonded to the annular base preform preferably by adhesion with a tacky shape-keeping material and/or stitching.

Substrates for forming the annular base preform, the annular, reinforcing flat-plate preform and the cylindrical, reinforcing preform are preferably braids of reinforcing fibers.

It is preferable to place the annular fiber preform on a molding die, cover the annular fiber preform and the molding die with a bag film, and inject the matrix resin into a space covered by the bag film through at least two pipes while keeping the space in vacuum, so that the annular fiber preform is impregnated with the matrix resin.

The annular, fiber-reinforced composite structure produced by the method of the present invention is suitable as an annular frame for aircraft fuselages.

### BRIEF DESCRIPTION OF THE DRAWINGS

FIG. 1 is a perspective view showing one example of annular fiber preforms used in the present invention;

FIG. 2 is a cross-sectional view taken along the line A-A in FIG. 1;

FIG. 3 is an exploded perspective view showing the structure of the annular fiber preform of FIG. 1;

FIG. 4 is a perspective view showing an long, planar, braided preform strip;

FIG. 5 is a perspective view showing the long, planar preform strip of FIG. 4, which is in a bent state.

FIG. 6 is a perspective view showing an annular base preform constituting the annular fiber preform of FIG. 1;

FIG. 7 is an enlarged perspective view showing a portion B in FIG. 6;

FIG. 8 is a perspective view showing an annular, reinforcing flat-plate preform constituting the annular fiber preform of FIG. 1;

FIG. 9 is an enlarged perspective view showing a portion C in FIG. 8;

FIG. 10 is a perspective view showing a cylindrical, reinforcing preform constituting the annular fiber preform of FIG. 1;

FIG. 11 is an enlarged perspective view showing a portion D in FIG. 10;

FIG. 12 is a perspective view showing another example of annular fiber preforms used in the present invention; FIG. 13 is a cross-sectional view taken along the line E-E in FIG. 12;

FIG. 14 is a perspective view showing a further example of annular fiber preforms used in the present invention;

FIG. 15 is a cross-sectional view taken along the line F-F in FIG. 14;

FIG. 16 is a plan view showing the annular fiber preform placed on a molding die for impregnating a resin;

FIG. 17 is a cross-sectional view taken along the line G-G in FIG. 16;

FIG. 18 is a plan view showing the annular fiber preform that is being impregnated with a resin by a vacuum injection method;

FIG. 19 is a cross-sectional view taken along the line H-H in FIG. 18;

FIG. 20 is a cross-sectional view taken along the line I-I in FIG. 18;

FIG. 21 is a cross-sectional view showing one example of aircraft fuselages constituted by the annular frame of the present invention;

FIG. 22 is a partial enlarged perspective view showing the aircraft fuselage of FIG. 21; and

FIG. 23 is a perspective view showing a conventional annular preform.

### DESCRIPTION OF THE PREFERRED EMBODIMENTS

[1] Annular fiber preform

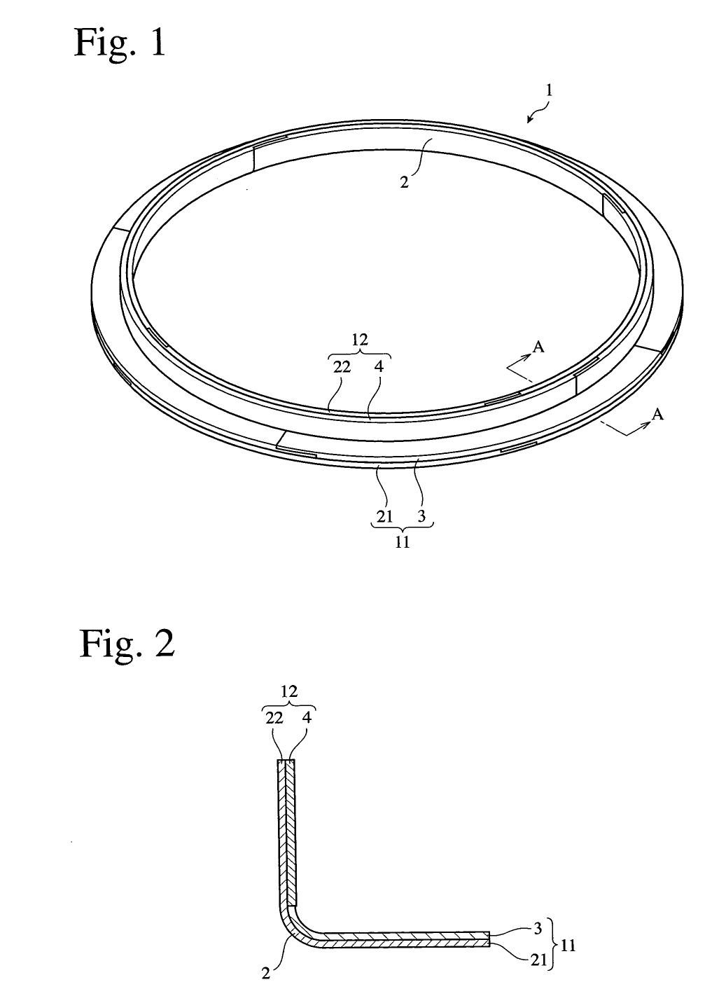

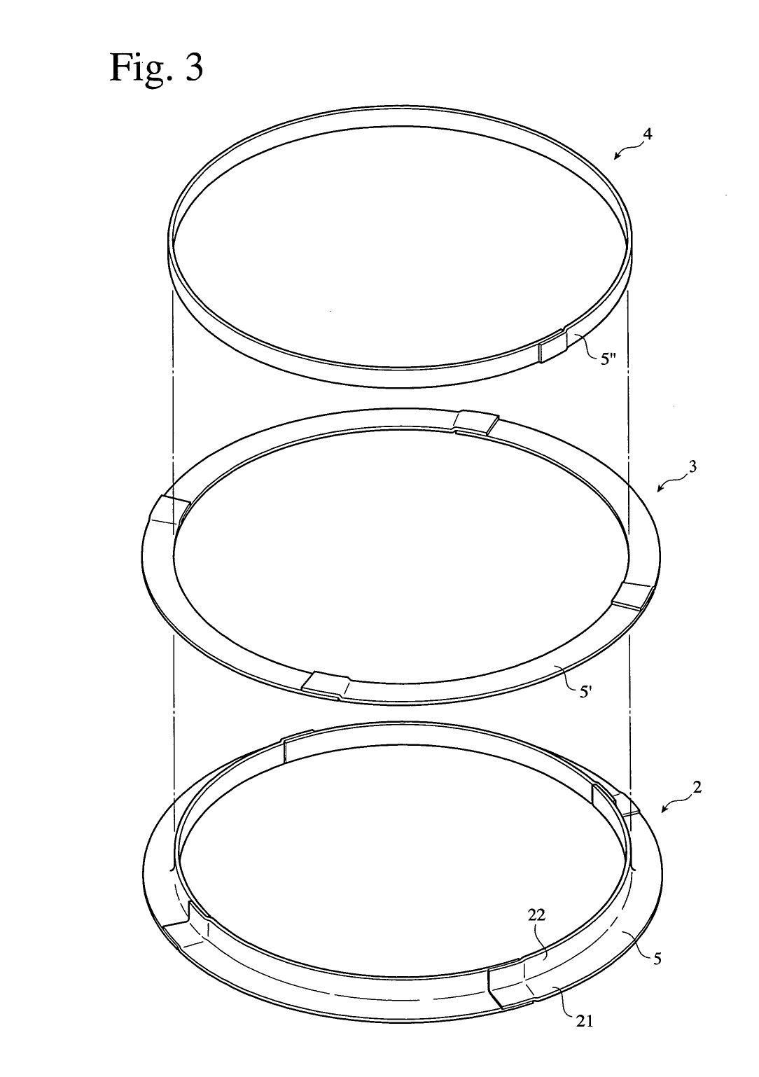

FIGS. 1-3 show one example of the annular fiber preforms formed in the method of the present invention for producing an annular, fiber-reinforced composite structure. The annular fiber preform 1 has an integral structure comprising (a) an annular base preform 2 having an annular flat-plate web 21, and a flange 22 substantially perpendicular to the web 21, (b) an annular, reinforcing flat-plate preform 3 bonded to the web 21 of the annular base preform 2, and (c) a cylindrical, reinforcing preform 4 bonded to the flange 22 of the annular base preform 2. Each preform 2-4 is composed of reinforcing fibers.

(1) Substrate

Each preform 2-4 is preferably a cloth substrate of reinforcing fibers. Though the reinforcing fiber cloth may be in any type, it is preferably at least one selected from the group consisting of braids, fabrics and knits. Braids and fabrics are more preferable from the aspect of cloth strength, and the braids are particularly preferable from the aspect of the degree of freedom of fiber orientation.

Though not particularly restricted, the reinforcing fibers may be properly selected from carbon fibers, aramide fibers, glass fibers, boron fibers, etc. depending on applications. When the annular, fiber-reinforced composite structure is used as an annular frame for aircraft fuselages, the reinforcing fibers are preferably carbon fibers.

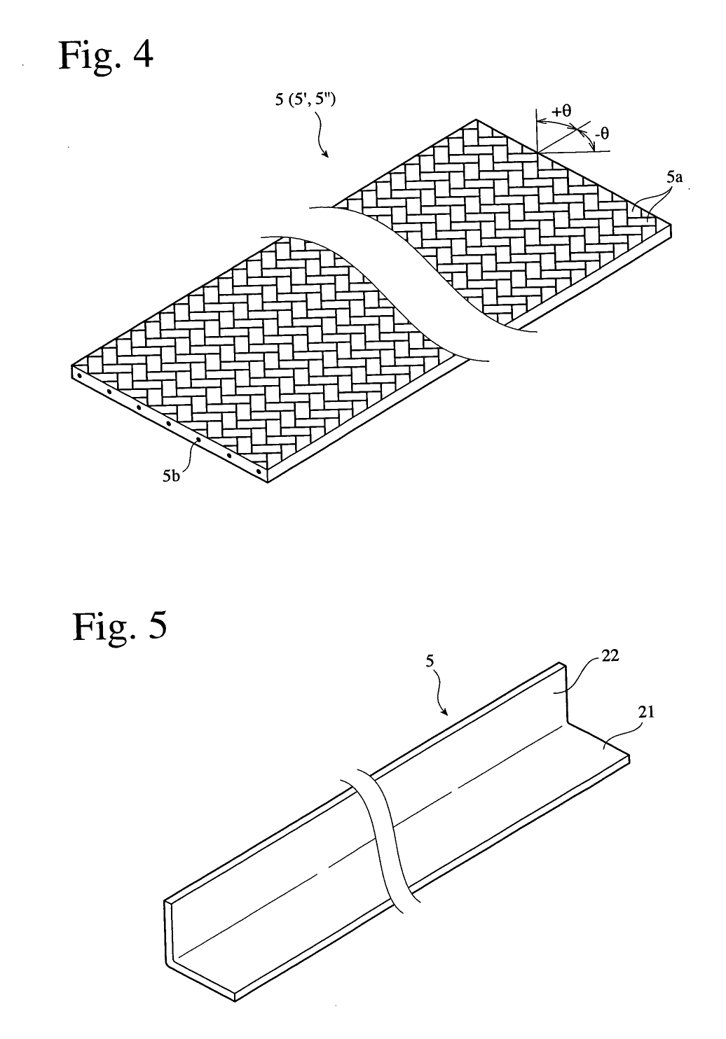

The reinforcing fiber cloth is preferably formed into an elongated planar strip, from which each preform 2-4 is obtained. FIG. 4 shows one example of long, braided, planar preform strips. The long, braided, planar preform strip 5 (5′, 5″) preferably has a three-axis fiber structure comprising center fibers 5b extending in a longitudinal direction (0°) and two fibers 5a, 5a inclined from the longitudinal direction by a predetermined braiding angle of ±0°. The inclined fibers 5a and the center fibers 5b are preferably bundles of pluralities of fibers. The basis weight of each preform 2-4 can be controlled by the number, denier, etc. of fibers constituting the inclined fibers 5a and/or the center fibers 5b.

(2) Production of Annular Fiber Preform

Taking a long, braided, planar preform strip as a substrate, the formation of an annular fiber preform 1 having an L-shaped cross section will be explained below.

(a) Annular Base Preform

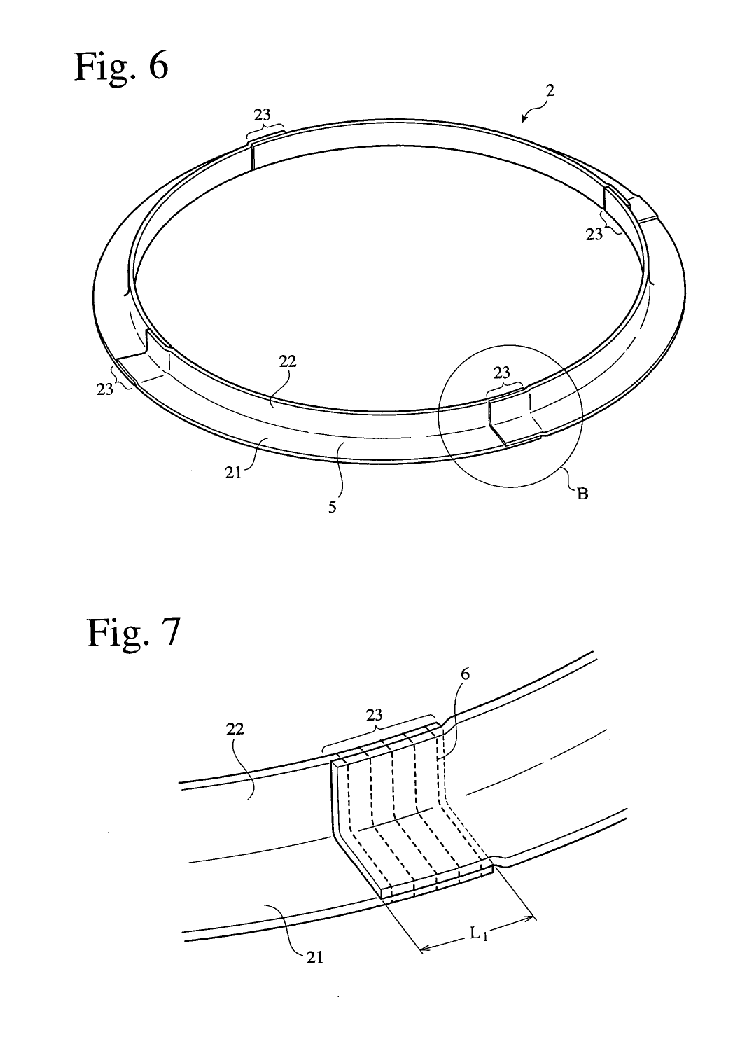

To form an annular base preform 2, for instance, a long, planar preform strip 5 as shown in FIG. 4 is provided with an L-shaped transverse cross section, to form a strip 5 having a flat portion 21 and a vertical portion 22 as shown in FIG. 5. After the strip 5 is circularly deformed with its vertical portion 22 inside as shown in FIG. 6, end portions of at least one circular strip 5 are overlap-bonded to provide an annular body. However, the long, planar preform strip 5 shown in FIG. 4 should not necessarily be deformed to an L-shaped cross section in advance, but may be provided with an L-shaped cross section after deformation to a circular flat-plate shape. There is no particular restriction in means for providing the strip 5 with an L-shaped cross section or circularly deforming the strip 5, and a press, etc. may be used.

The number of circular strips 5 constituting an annular base preform 2 is preferably 2-8, more preferably 3-7. If the number were one, one long, planar preform strip 5 having a flat portion 21 and a vertical portion 22 would have to be annularly deformed, resulting in difficulty in uniform deformation. If the number were 9 or more, a lengthy overlap-bonding operation of the circular strips 5 would be needed, resulting in many overlap-bonded portions 23 in the resultant annular base preform 2. Thus, it would be unpreferable from the aspects of the production cost and weight of the annular base preform 2.

Stitching 6 as shown in FIG. 7 is preferable to overlap-bond the end portions of the circular strips 5. To provide the annular base preform 2 to be formed with sufficient strength and rigidity, the circumferential length L₁ of each overlap-bonded portion 23 is preferably 20-30 mm regardless of the size of the annular base preform 2.

The basis weight of the annular base preform 2 may be properly determined depending on the applications of the annular fiber preform 1. After the long, planar preform strip 5 shown in FIG. 4 is deformed to an annular body as described above, the basis weight of the long, planar preform strip 5 may be partially adjusted in an available range, such that a portion formed into the flange 22 has a larger basis weight than that of a portion formed into the web 21.

(b) Annular, Reinforcing Flat-Plate Preform

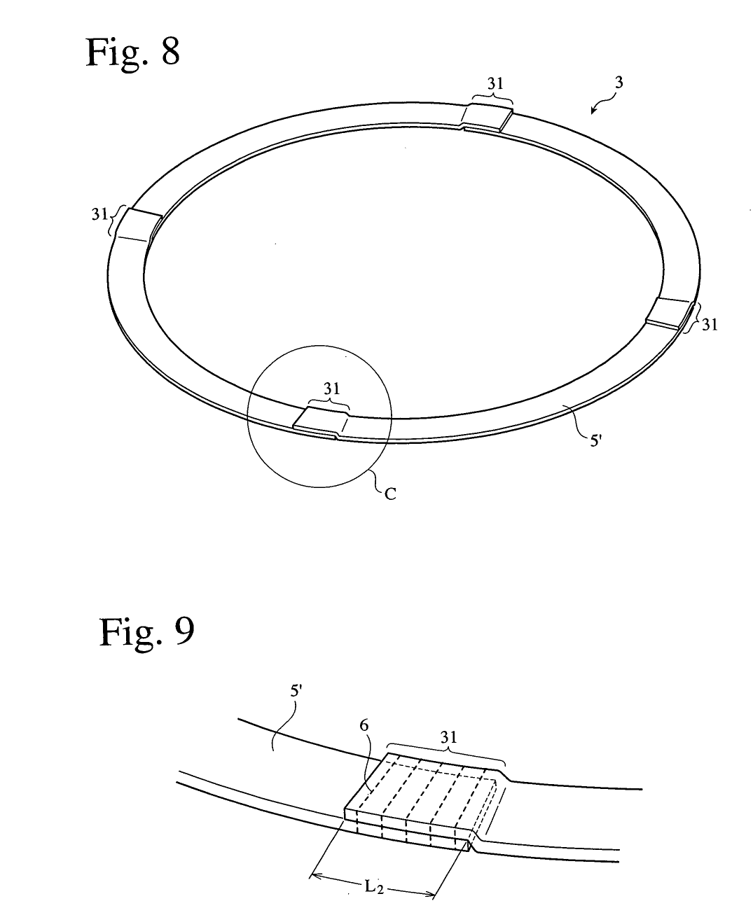

To form the annular, reinforcing flat-plate preform 3, at least one long, planar preform strip 5′ shown in FIG. 4 having, for instance, substantially the same width as the radial length of the web 21 of the annular base preform 2 is formed. After the resultant long, planar preform strip 5′ is deformed to a circular, planar shape, its end portions are overlap-bonded to provide an annular body as shown in FIGS. 8 and 9.

The number of the circular strips 5′ constituting the annular, reinforcing flat-plate preform 3 is preferably 2-8, more preferably 3-7, for the same reasons as in the annular base preform 2. Because the overlap-bonding method of the circular, planar strips 5′ and the circumferential length L₂ of the overlap-bonded portions 31 may be the same as in the annular base preform 2, their explanation is omitted. The basis weight of the annular, reinforcing flat-plate preform 3 may be properly determined depending on the applications of the annular fiber preform 1.

(c) Annular, Reinforcing Preform

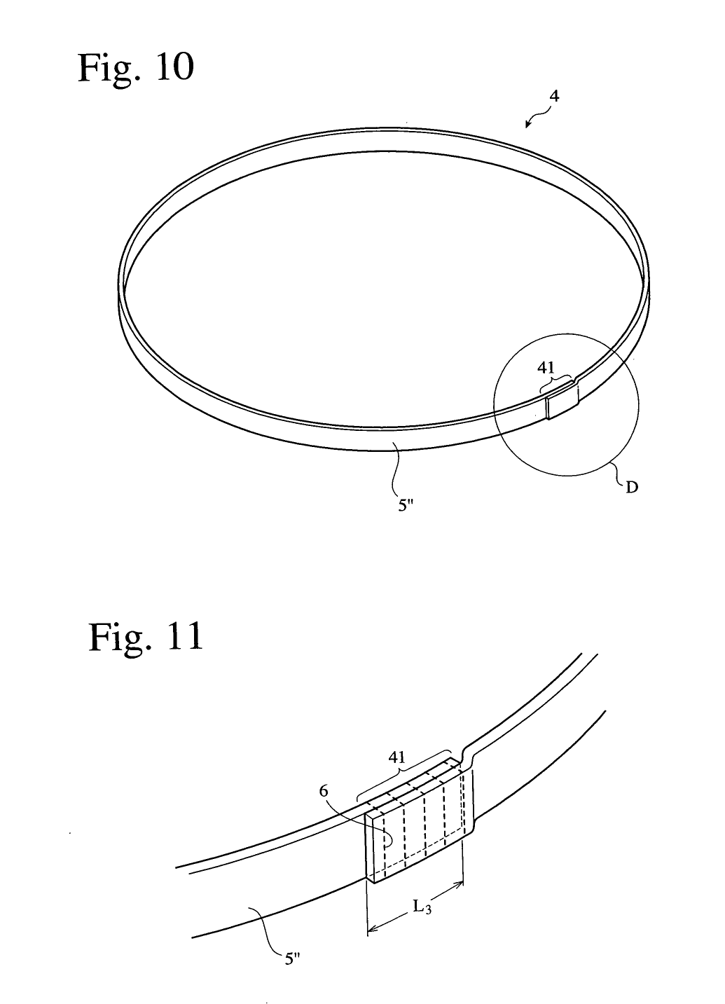

After a long, planar preform strip 5″ shown in FIG. 4 having, for instance, substantially the same width as the width (longitudinal length) of the flange 22 of the annular base preform 2 is annularly deformed, both of its end portions are overlap-bonded to provide a cylindrical, reinforcing preform 4 as shown in FIGS. 10 and 11. Though the cylindrical, reinforcing preform 4 may usually be constituted by one long, planar preform strip 5″, it may be constituted by pluralities of preform strips 5″, if necessary.

Because the overlap-bonding method of the annular strip 5″ and the circumferential length L₃ of an overlap-bonded portion 41 may be the same as in the annular base preform 2, their explanation is omitted. The basis weight of the cylindrical, reinforcing preform 4 may be properly determined depending on the applications of the annular fiber preform 1.

(d) Annular Fiber Preform

As shown in FIGS. 1-3, the annular fiber preform 1 is formed, for instance, by bonding the annular, reinforcing flat-plate preform 3 to the web 21 of the annular base preform 2 on the side of the flange 22, and bonding the cylindrical, reinforcing preform 4 to an outer surface of the flange 22 of the annular base preform 2. Usable in their bonding is a molding die having a vertical portion coming into contact with an inner surface of the flange 22 of the annular base preform 2 and a flat portion coming into contact with a bottom surface of the annular base preform 2.

Instead of forming the cylindrical, reinforcing preform 4 in advance, one long, planar preform strip 5″ may be wound around the flange 22, to conduct the formation of the cylindrical, reinforcing preform 4 and its bonding to the flange 22 simultaneously.

To provide the annular fiber preform 1 with high rigidity, the preforms 2-4 are arranged such that the overlap-bonded portions 23 of the annular base preform 2, the overlap-bonded portions 31 of the annular, reinforcing flat-plate preform 3, and the overlap-bonded portions 41 of the cylindrical, reinforcing preform 4 are circumferentially deviated from each other on the annular fiber preform 1.

The annular, reinforcing flat-plate preform 3 and the cylindrical, reinforcing preform 4 are bonded to the annular base preform 2 preferably by adhesion using tacky shape-keeping materials and/or stitching. The tacky shape-keeping materials may be adhesives, bonds, etc. By such bonding method, the annular fiber preform 1 can keep its shape until it is impregnated with a matrix resin.

The preferred bonding method is an adhesion method using shape-keeping materials. The preferred shape-keeping materials are epoxy adhesives. The amount of a shape-keeping material used is preferably 1-5% by mass based on the total amount (100% by mass) of the matrix resin and the shape-keeping material.

The annular fiber preform 1 produced by the above method has a desired basis weight in the web 11 and the flange 12.

(3) Other Embodiments

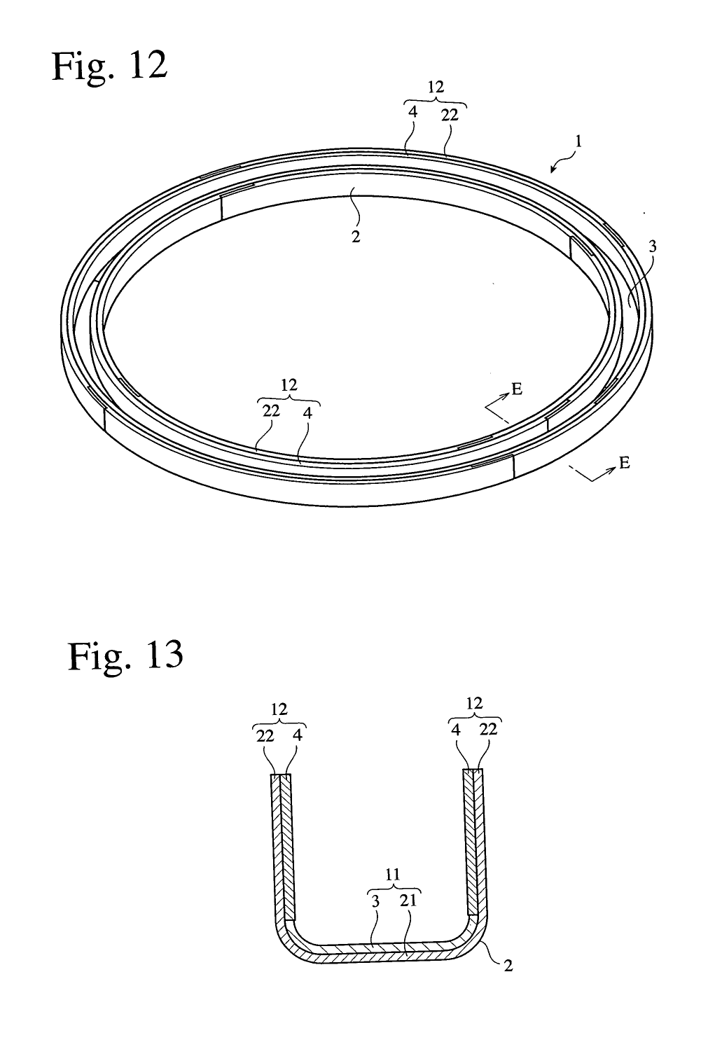

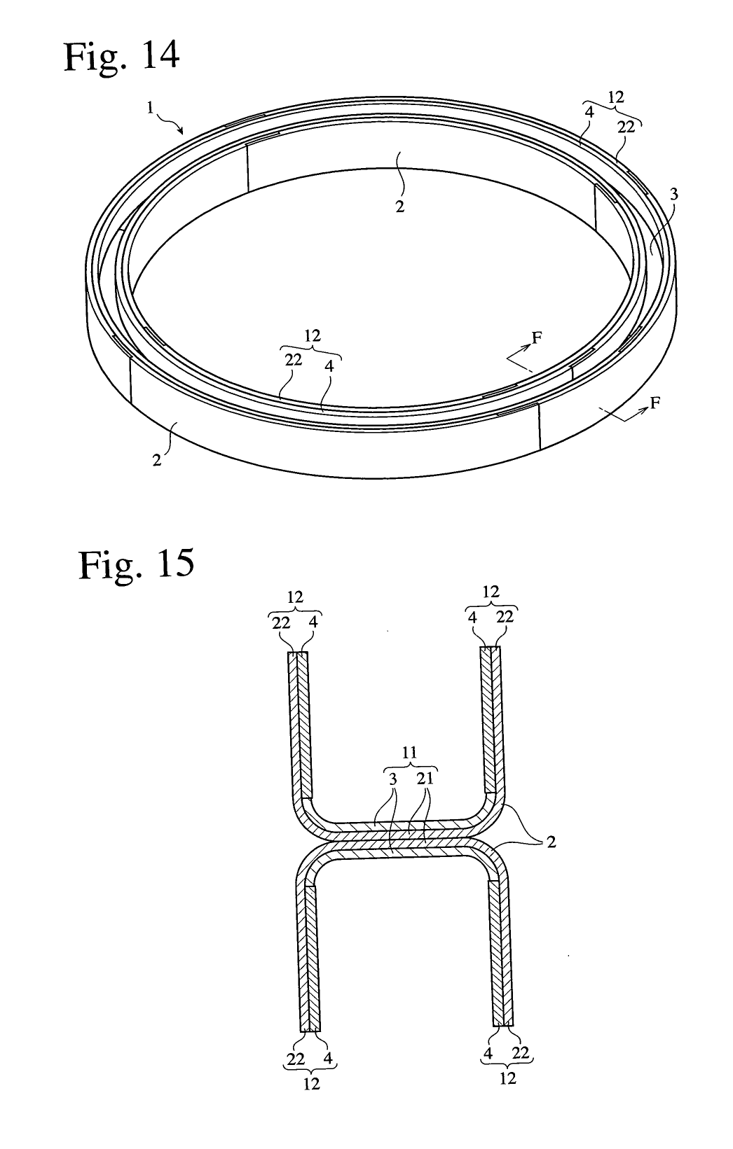

The annular fiber preform 1 is not restricted to have an L-shaped cross section, but may have a different cross section shape, if necessary. It may have, for instance, a U-shaped cross section as shown in FIGS. 12 and 13 or an H-shaped cross section as shown in FIGS. 14 and 15. The annular fiber preform 1 having a U-shaped cross section may be produced, for instance, by deforming the long, planar preform strip 5 shown in FIG. 4 to a U-shaped cross section to have two flanges 22, 22, bonding each cylindrical, reinforcing preform 4, 4 to each flange 22, 22, and bonding the annular, reinforcing flat-plate preform 3 to the web 21. In the case of the U-shaped cross section, an annular fiber preform 1 having flanges 12, 12 on both sides of the web 11 as shown in FIGS. 12 and 13 can be obtained.

The annular fiber preform 1 having an H-shaped cross section may be produced, for instance, by forming two annular fiber preforms each having a U-shaped cross section as shown in FIGS. 12 and 13 in a manner described above, and bonding the webs 21, 21 of both annular fiber preforms as shown in FIGS. 14 and 15. In the case of the H-shaped cross section, an annular fiber preform 1 having flanges 12, 12 projecting from both ends of the web 11 in both axial directions can be obtained as shown in FIGS. 14 and 15.

[2] Production of Annular, Fiber-Reinforced Composite Structure

The annular, fiber-reinforced composite structure is produced by impregnating the annular fiber preform 1 formed above with a matrix resin (hereinafter referred to as “resin” unless otherwise mentioned), and curing the resin.

The method of impregnating the annular fiber preform 1 with a resin is not particularly restricted, but may be a known method. The resin-impregnating methods include, for instance, a vacuum injection method in which a resin is injected into an evacuated space, a resin transfer molding (RTM) method in which a resin is introduced under pressure, a vacuum-assisted resin transfer molding (VARTM) method which is a combination of these methods, etc.

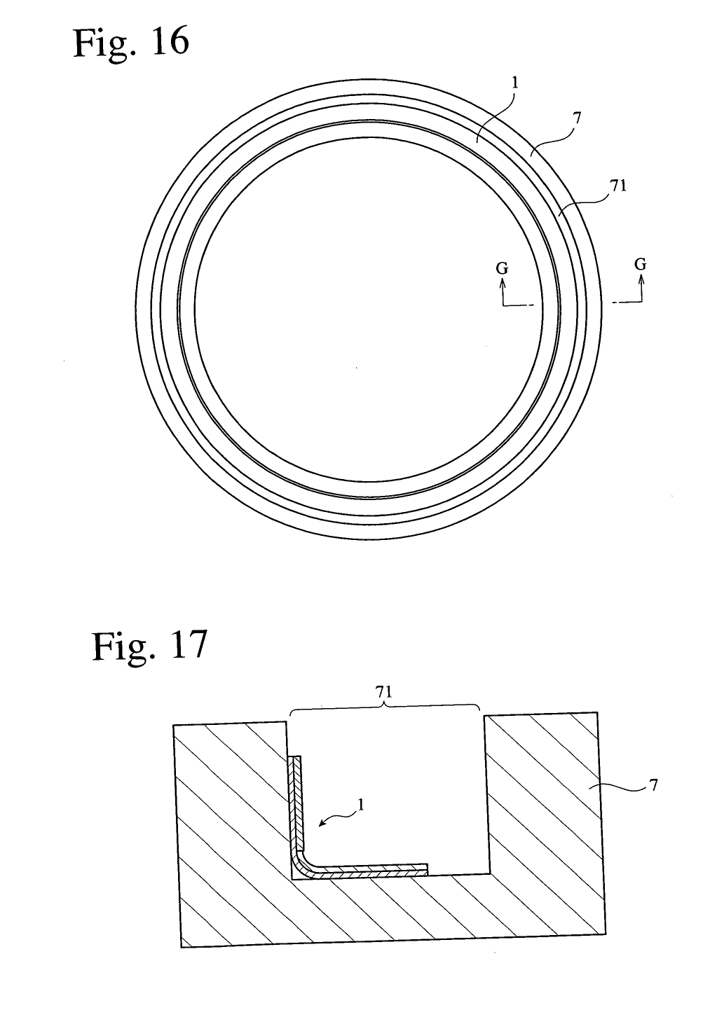

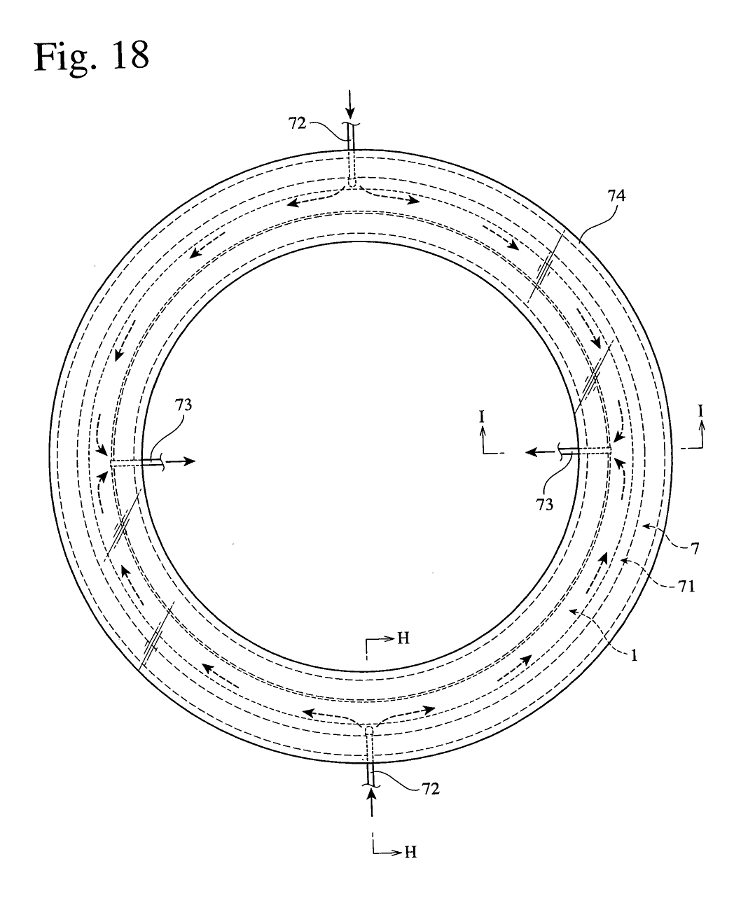

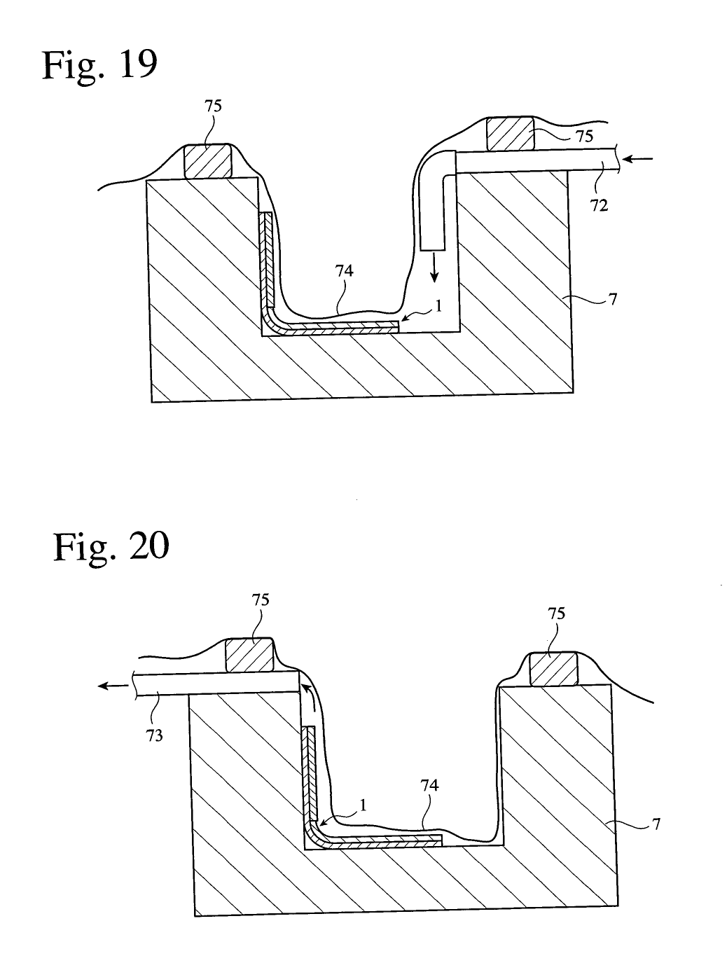

The impregnation of the annular fiber preform 1 having an L-shaped cross section with a resin by a vacuum injection method will be explained referring to the drawings. The annular fiber preform 1 is first placed in a groove 71 of an annular molding die 7 as shown in FIGS. 16 and 17. While evacuating the groove 71 of the molding die 7 covered with a bag film 74 through pipes 73 connected to a suction means such as a vacuum pump, etc., a resin is injected into the groove 71 through pipes 72, as shown in FIGS. 18-20. The bag film 74 is fixed to an upper surface of the molding die 7 by an adhesion tape 75 to keep the groove 71 in a vacuum state. As shown in FIG. 18, the injected resin flowing along the groove 71 enters into the annular fiber preform 1, so that the annular fiber preform 1 is fully impregnated with the resin.

The number of the resin-injecting pipes 72 is preferably at least 2. With two or more resin-injecting pipes 72, the annular fiber preform 1 can be uniformly impregnated with the resin, resulting in a shorter resin injection time, and reduced pores in the resin-impregnated preform. As shown in FIG. 18, Pluralities of the resin-injecting pipes 72 are disposed along the molding die 7 at substantially equal intervals.

The number of the suction pipes 73 is also preferably two or more for the same reasons as in the resin-injecting pipes 72. As shown in FIG. 18, pluralities of the suction pipes 73 are preferably disposed along the molding die 7 at substantially equal intervals between the resin-injecting pipes 72.

The molding die may be made of materials such as CFRP, steel, aluminum, silicone rubbers, etc. When the RTM or VARTM method is used, the molding die is constituted by upper and lower die parts, because the resin is injected under pressure into a cavity therebetween.

The resins may be thermosetting resins or thermoplastic resins. The thermosetting resins include epoxy resins, polyurethanes, unsaturated polyesters, bismaleimide resins, phenol resins, etc. The thermoplastic resins include polyamides such as nylon; polyimides; polyesters such as polyethylene terephthalate and polybutylene terephthalate; polyacetal; polyphenylene sulfide; polyetheretherketon (PEEK); polyetherketon, etc.

From the aspects of mechanical strength and heat resistance, a combination of carbon fibers and epoxy resins or PEEK is preferable. The percentage of the resin to the reinforcing fibers may be arbitrarily determined.

Commercially available epoxy resins include ADR285 (available from Adhesive Technologies), etc., and commercially available carbon fiber-reinforced PEEK includes APC-2 (available from Cytec Fiberite), etc. In the case of using a thermosetting resin, additives such as curing agents, etc. may be added. Curing agents commercially available for ADR285 include ADH150 (available from Adhesive Technologies).

When the impregnating resin is a thermosetting resin, it is cured.

When the epoxy resin is used, it is heat-cured in an oven, etc. It may be compressed using an autoclave, etc., if necessary.

[3] Annular, Fiber-Reinforced Composite Structure

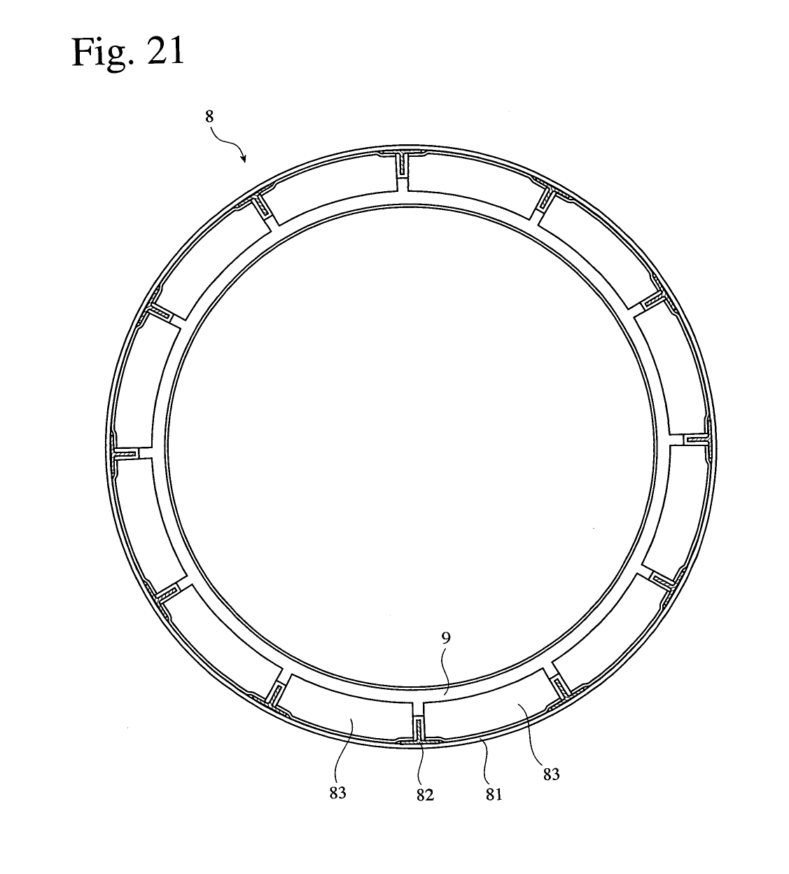

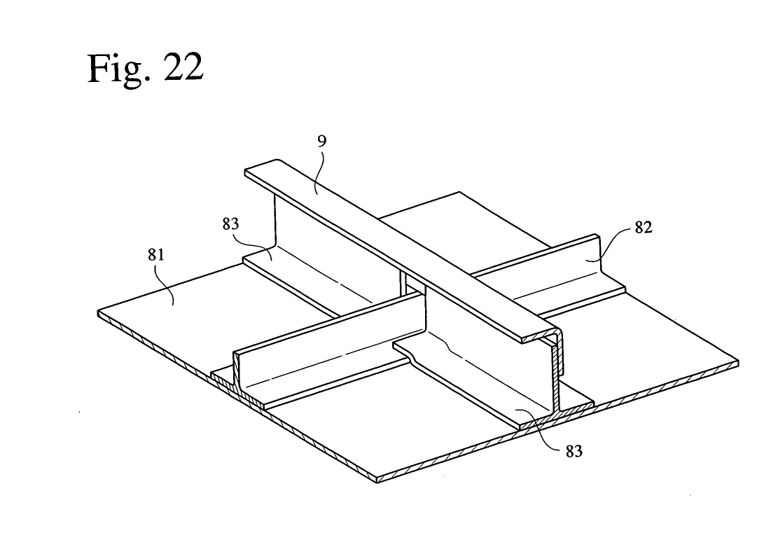

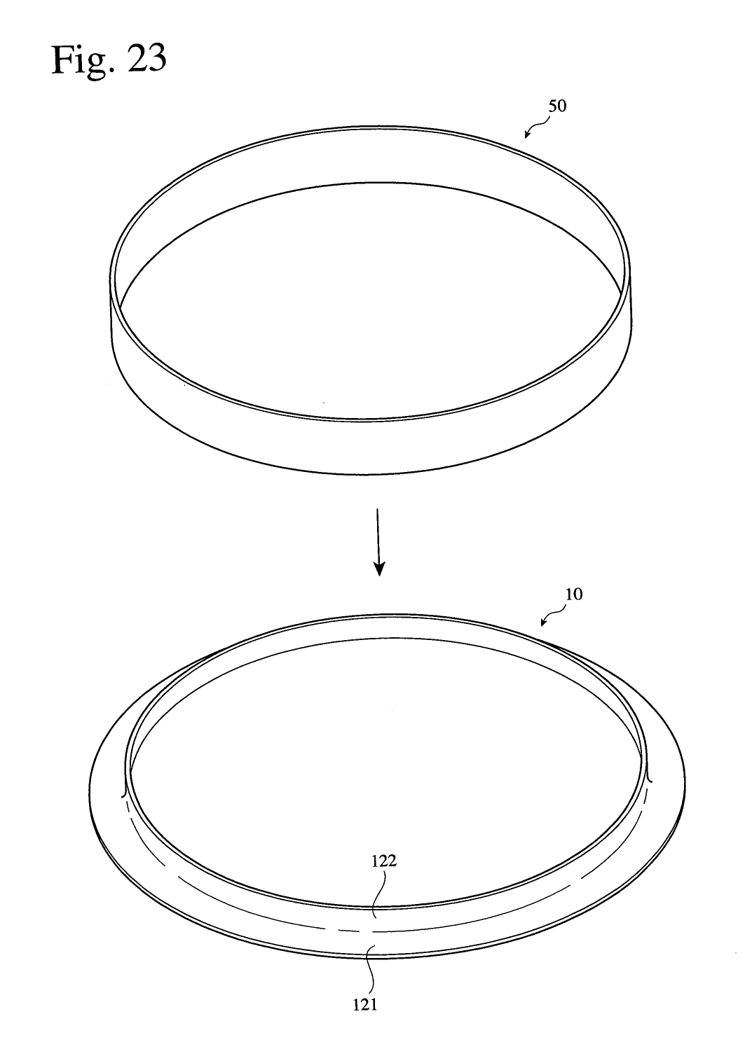

The annular, fiber-reinforced composite structure produced above is light in weight and has high strength, suitable as an annular frame for aircraft fuselages. FIGS. 21 and 22 show an example of aircraft fuselages formed from the annular, fiber-reinforced composite structure obtained by the method of the present invention. FIG. 22 is a partial perspective view showing the fuselage structure of FIG. 21. Though FIG. 22 depicts each member in a flat-plate shape, it actually has a curved surface. As shown in FIG. 21, an fuselage structure 8 comprises a skin 81, axially extending low stringer members 82, outer frame members 83, and inner frame members 9, which abut the outer frame members 83. As shown in FIG. 22, the fuselage structure 8 can be formed by arranging pluralities of stringer members 82 and pluralities of outer frame members 83 on the skin 81 composed of a fiber-reinforced composite placed on a molding die (not shown), integrally curing them, abutting the annular frames 9 to the outer frame members 83 and adhering them.

Though the annular frame 9 for aircraft fuselages shown in FIGS. 21 and 22 has a circular cross section, the method of the present invention can also produce annular frames for aircraft fuselages having various cross section shapes such as an elliptic cross section, etc. The annular, fiber-reinforced composite structures produced by the method of the present invention are suitable not only for aircrafts, but also for automobiles, vessels, etc.

### EFFECT OF THE INVENTION

The method of the present invention can produce an annular, fiber-reinforced composite structure having a web and a flange with optimum rigidity by smaller numbers of steps than in a conventional method comprising stitching pluralities of planar prepregs and curing an impregnating resin, resulting in a reduced production cost. In addition, the web and flange of the annular, fiber-reinforced composite structure can be easily provided with desired rigidity.

Though the present invention has been explained above referring to the drawings, it is not restricted thereto, and various modifications may be added unless they deviated from the scope of the present invention.

1. A method for producing an annular, fiber-reinforced composite structure comprising the steps of (a) forming reinforcing fibers into an annular base preform having an annular flat-plate web and a flange substantially perpendicular to said web, (b) bonding an annular, reinforcing, flat-plate fiber preform to the web of said annular base preform, (c) bonding a cylindrical, reinforcing fiber preform to the flange of said annular base preform to form an integral, annular fiber preform, (d) impregnating the resultant annular fiber preform with a matrix resin, and (e) curing said matrix resin.

2. The method for producing an annular, fiber-reinforced composite structure according to claim 1, wherein (a) said annular base preform is formed by overlap-bonding end portions of at least one circular strip obtained by deforming an elongated planar strip composed of reinforcing fibers to a shape having a circular flat portion and a portion substantially perpendicular to said flat portion, (b) said annular, reinforcing flat-plate preform is formed by overlap-bonding end portions of at least one circular, planar strip obtained by deforming an elongated planar strip composed of reinforcing fibers to a circular shape, (c) said cylindrical, reinforcing preform is formed by overlap-bonding both end portions of at least one annular strip obtained by annularly deforming an elongated planar strip composed of reinforcing fibers, and (d) said annular fiber preform is formed by bonding said annular, reinforcing flat-plate preform and said cylindrical, reinforcing preform to said annular base preform with their overlapped portions deviating from each other in a circumferential direction of said annular fiber preform.

3. The method for producing an annular, fiber-reinforced composite structure according to claim 1, wherein said annular base preform has an L-, U- or H-shaped cross section.

4. The method for producing an annular, fiber-reinforced composite structure according to claim 1, wherein said annular, reinforcing flat-plate preform and said cylindrical, reinforcing preform are bonded to said annular base preform by adhesion with a tacky shape-keeping material and/or stitching.

5. The method for producing an annular, fiber-reinforced composite structure according to claim 1, wherein substrates for forming said annular base preform, said annular, reinforcing flat-plate preform and said cylindrical, reinforcing preform are braids of reinforcing fibers.

6. The method for producing an annular, fiber-reinforced composite structure according to claim 1, comprising placing said annular fiber preform on a molding die, covering said annular fiber preform and said molding die with a bag film, and injecting said matrix resin into a space covered by said bag film through at least two pipes while keeping said space in vacuum, so that said annular fiber preform is impregnated with said matrix resin.

7. An annular frame for aircraft fuselages, which is produced by the method recited in claim 1.

8. An annular frame for aircraft fuselages, which is produced by the method recited in claim 2.

9. An annular frame for aircraft fuselages, which is produced by the method recited in claim 3.

10. An annular frame for aircraft fuselages, which is produced by the method recited in claim 4.

11. An annular frame for aircraft fuselages, which is produced by the method recited in claim 5.

12. An annular frame for aircraft fuselages, which is produced by the method recited in claim 6.
